(19) United States
(12) Patent Application Publication
(10) Pub. No.: US 2026/0212305 A1
(43) Pub. Date: Jul. 23, 2026

(54) HOME SCORES DETERMINED FROM LOCATION AND/OR PROPERTY SUBSCORES

(71) Applicant: STATE FARM MUTUAL AUTOMOBILE INSURANCE COMPANY, Bloomington, IL (US)

(72) Inventors: Laura A. Uphoff, Normal, IL (US); Sean Hickey, Albuquerque, NM (US); Jason Goldfarb, Bloomington, IL (US)

(21) Appl. No.: 19/092,554

(22) Filed: Mar. 27, 2025

Related U.S. Application Data
(60) Provisional application No. 63/748,742, filed on Jan. 23, 2025.

(51) Int. Cl. G06Q 10/0639; G06Q 40/08; G06Q 50/163

(52) U.S. Cl. CPC G06Q 10/06393; G06Q 40/08; G06Q 50/163

(57) ABSTRACT

The following relates generally to determining and/or displaying a home score and/or homeowner points. In some embodiments, one or more processors: (1) determine a location subscore; (2) determine a property subscore; (3) determine a home score based upon the location subscore and/or property subscore; (4) determine homeowner points based upon completion of one or more insights; and/or (5) display the home score and/or the homeowner points.

### CROSS REFERENCE TO RELATED APPLICATIONS

This application claims the benefit of U.S. Provisional Application No. 63/748,742, entitled “Home Scores Determined From Location and/or Property Subscores” (filed Jan. 23, 2025), the entirety of which is incorporated by reference herein.

### FIELD

The present disclosure generally relates to determining and/or displaying a home score and/or homeowner points.

### BACKGROUND

Determining and/or presenting a home score (e.g., a score rating a home, etc.) and/or homeowner points (e.g., points awarded in response to upgrading a home, etc.) may be important to an insurance company. For example, when an insurance customer's home has a high home score, the insurance company may offer the customer a discount on homeowners insurance. However, present systems for determining home scores and/or homeowners points may have certain drawbacks.

The systems and methods disclosed herein may provide solutions to these problems and may provide solutions to the ineffectiveness, insecurities, difficulties, inefficiencies, encumbrances, and/or other drawbacks of conventional techniques.

### SUMMARY

A home score may be determined from a location subscore and/or a property subscore. The home score may be useful, for example, for offering an insurance customer a discount for homeowners insurance and/or for assessing the value of a home. The location subscore may be based upon attributes, such as a natural hazards attribute, an emergency response attribute, a health/safety attribute, etc. The property subscore may be based upon attributes, such as a structure attribute, a systems/appliances attribute, a premises attribute, a fire/electric attribute, a security attribute, a plumbing attribute, etc. Homeowner points may also be calculated. For example, when an insight (e.g., a recommended project to improve a home, etc.) is completed, the homeowner may be awarded homeowner points.

In one aspect, a computer-implemented method for determining and/or displaying: a home score and/or homeowner points may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the computer-implemented method may include: (1) determining, via one or more processors, a location subscore (such as from (i) location attributes; (ii) location variables; and/or (iii) various types of sensor data and other types of data and information); (2) determining, via the one or more processors, a property subscore (such as from (i) property attributes; (ii) property variables; and/or (iii) various types of sensor data and other types of data and information); (3) determining, via the one or more processors, a home score based upon the location subscore and/or property subscore; (4) determining, via the one or more processors, homeowner points based upon completion of one or more insights; and/or (5) displaying, via the one or more processors, the home score and/or the homeowner points. The method may include additional, fewer, or alternate actions, including those discussed elsewhere herein.

In another aspect, a computer device configured for determining and/or displaying: a home score and/or homeowner points may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) determine a location subscore (such as from (i) location attributes; (ii) location variables; and/or (iii) various types of sensor data and other types of data and information); (2) determine a property subscore (such as from (i) property attributes; (ii) property variables; and/or (iii) various types of sensor data and other types of data and information); (3) determine a home score based upon the location subscore and/or property subscore; (4) determine homeowner points based upon completion of one or more insights; and/or (5) display the home score and/or the homeowner points. The computer device may include additional, less, or alternate functionality, including that discussed elsewhere herein.

In yet another aspect, a computer system configured for determining and/or displaying: a home score and/or homeowner points may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) determine a location subscore (such as from various attributes, from various types of related sensor data and other types of data and information, etc.); (2) determine a property subscore (such as from various attributes, from various types of related sensor data and other types of data and information, etc.); (3) determine a home score based upon the location subscore and/or property subscore; (4) determine homeowner points based upon completion of one or more insights; and/or (5) display the home score and/or the homeowner points. The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts an exemplary system for determining and/or displaying: a home score and/or homeowner points, according to one embodiment.

FIG. 2 depicts an exemplary display including a home score, and homeowner points.

FIG. 3 depicts an exemplary display including a location subscore.

FIG. 4 depicts an exemplary display including a property subscore.

FIG. 5 depicts a flow diagram representing an exemplary computer-implemented method or implementation for determining and/or displaying: a home score and/or homeowner points.

FIG. 6 depicts an exemplary earthquake variable.

FIG. 7 depicts an exemplary smoke detector variable.

FIG. 8 depicts exemplary matrix of smart smoke detectors indicating points that the smart smoke detectors may increase the smoke detector variable, fire/electric attribute, property subscore, and/or home score by.

FIG. 9 depicts an exemplary structural attribute.

FIG. 10 depicts an exemplary screen displaying an exemplary insight.

FIG. 11 depicts a block diagram of an exemplary machine learning modeling method for training and evaluating exemplary machine learning model(s).

### DETAILED DESCRIPTION

The present techniques provide systems and methods for determining and/or displaying a home score and/or homeowner points, leveraging a comprehensive approach that evaluates a home. These techniques utilize one or more processors to calculate a home score based upon a location subscore and/or a property subscore. The location subscore may be derived from (i) attributes, such as a natural hazards attribute, an emergency response attribute, and/or a health/safety attribute; and/or (ii) various types of related sensor data, as well as other types of related data and information, including those discussed elsewhere herein. On the other hand, the property subscore may be derived from (i) attributes, such as a structure attribute, a systems/appliances attribute, a premises attribute, a fire/electric attribute, a security attribute, and/or a plumbing attribute; and/or (ii) various types of related sensor data, as well as other types of data and information, including those discussed elsewhere herein. This dual-faceted assessment offers a nuanced understanding of a property's overall condition and safety, which can be instrumental for insurance companies in offering discounts or assessing home value, and for homeowners in understanding and improving their property's standing. In addition, some embodiments include determining homeowner points, which enhances a user's experience in improving her home.

One of the significant improvements introduced by the present techniques is the enhancement of processing efficiency. By structuring the assessment into location and property subscores, the method advantageously allows for a segmented analysis that can be executed more swiftly and updated independently as changes occur, such as improvements or upgrades to the property. This segmentation not only streamlines the calculation process but also facilitates a more dynamic and responsive system for score adjustment.

Another notable improvement is the optimized use of network resources. The method's design to determine homeowner points based upon the completion of various home maintenance and safety insights, such as checking smoke detector batteries or performing water heater maintenance, involves verifying completion through the analysis of receipts, photos, or contractor verification. This verification process leverages network communications to upload evidence or receive confirmations, employing efficient data transmission protocols and/or compression techniques to minimize network load and enhance the system's responsiveness.

The display of the home score and/or homeowner points is another area where the present techniques excel. By displaying the home score prominently in an upper portion of a display and the homeowner points in a lower portion, the method ensures that users can easily comprehend and appreciate the significance of these metrics. This thoughtful arrangement not only enhances user experience but also encourages homeowners to engage with the insights and take proactive steps towards improving their home's score and, by extension, its safety, security, and value.

In summary, the present techniques offer a comprehensive and efficient method for assessing and/or displaying a home's score and homeowner points, with significant improvements in processing efficiency, network and memory usage, and user interface design. These improvements collectively contribute to a system that is not only more effective in evaluating and communicating a home's condition but also more engaging and useful for homeowners and insurance providers alike.

### Exemplary Computer System

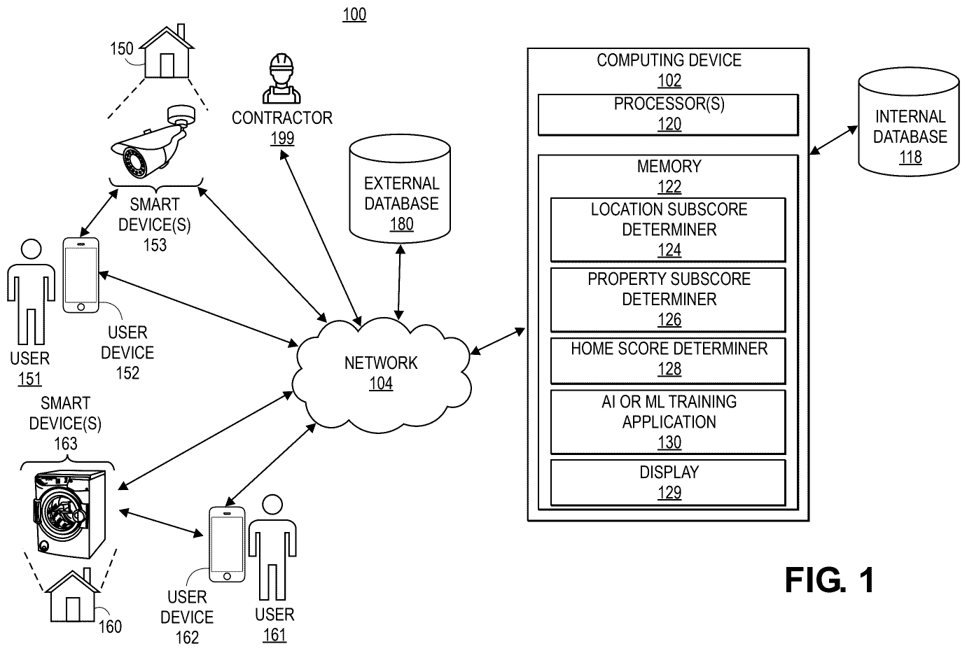

To this end, FIG. 1 illustrates an exemplary computer system 100 for determining and/or displaying: a home score and/or homeowner points in which the exemplary computer-implemented methods described herein may be implemented. The high-level architecture includes both hardware and software applications, as well as various data communications channels for communicating data between the various hardware and software components.

The computing device 102 may include one or more processors 120 such as one or more microprocessors, controllers, and/or any other suitable type of processor. The computing device 102 may further include a memory 122 (e.g., volatile memory, non-volatile memory) accessible by the one or more processors 120 (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 122 may include instructions for executing various applications, such as location subscore determiner 124, property subscore determiner 126, home score determiner 128, and/or artificial intelligence (AI) or machine learning (ML) training application 130. The computing device 102 may further include display 129.

In some examples, an insurance company owns the computing device 102, and the insurance company may provide insurance, such as homeowners or renters insurance, to the user 151, 161. Such an insurance company may provide an app for to the user 151, 161 (e.g., via the user device 152, 162. For example, the app may provide a home score (e.g., determined by the home score determiner 128). The home score may be based upon a location subscore (e.g., determined by the location subscore determiner), and/or a property subscore (e.g., determined by the property subscore determiner 126). Advantageously, the app may be used to provide the user 151, 161 with insurance discount(s) (e.g., for homeowners insurance, renters insurance, etc.). For instance, the insurance company may provide an insurance discount to the user based upon the home score, location subscore, and/or property subscore.

In some embodiments, the home score, location subscore, and/or property subscore may be generated, at least in part, from sensor data from the home 150, 160. Such sensor data may come from smart device(s) 153, 163.

Any or all of the home score, location subscore, and/or property subscore may be generated with or without the use of artificial intelligence (AI) and/or machine learning (ML). In some examples using AI and/or ML, an AI and/or ML algorithm or model may be trained by the AI and/or ML training application 130.

In addition, the app may provide homeowner points. In some examples, the homeowners points are based upon completion of an insight (e.g., a recommended project to improve the property 150, 160, a recommendation to learn a new homeowner skill (e.g., learning how to shut off a water main valve, etc.), etc.) Completing the insights may benefit both the user 151, 161 and the insurance company. For example, if an insight to complete installing a sump pump is completed, it is less likely that the basement of the home 150, 160 will flood, which benefits both the user 151, 161 and the insurance company. In some such examples, the app may provide discounts on and/or recommendations for products and/or services to complete the insight. Additionally or alternatively, the app may provide discounts on insurance to reward the user for well maintaining their home 150, 160.

Any of the users 151, 161 may use their respective user devices 152, 162 to view the recommended insights, and/or home score(s) (e.g., via a display of the user device 152, 162). The user devices 152, 162 may be any suitable device, such as a computer, a mobile device, a smartphone, a laptop, a phablet, a chatbot or voice bot, etc. The user device 152, 162 may include one or more display devices, one or more processors, one or more memories, etc.

In addition, further regarding the example system 100, the illustrated exemplary components may be configured to communicate, e.g., via a network 104 (which may be a wired or wireless network, such as the internet), with any other component. Furthermore, although the example system 100 illustrates certain number(s) of each of the components, any number of the example components are contemplated (e.g., any number of users, user devices, homes, smart devices, computing devices, databases, contractors, etc.).

### Exemplary Displays

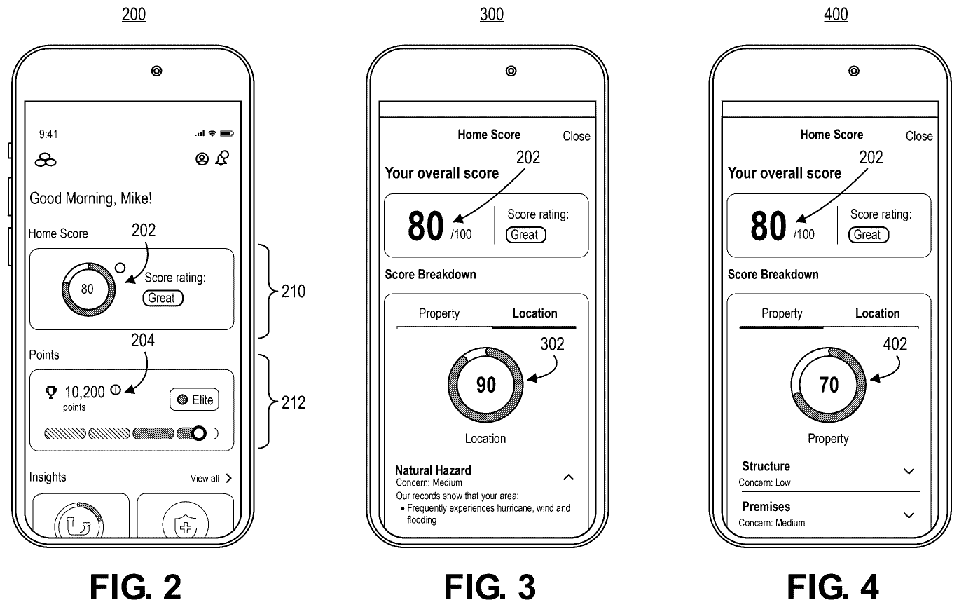

FIG. 2 depicts an exemplary display 200 (e.g., displayed on a display of the user device, 152, 162, a display of the smart device 153, 163, or the display 129, etc.). The exemplary display 200 includes home score 202, and homeowner points 204.

FIG. 3 depicts an exemplary display 300 (e.g., displayed on a display of the user device, 152, 162, a display of the smart device 153, 163, or the display 129, etc.). The exemplary display 300 includes home score 202, and location subscore 302. The location subscore 302 may be derived as described elsewhere herein, such as from (i) location attributes, such as a natural hazards attribute, an emergency response attribute, and/or a health/safety attribute; (ii) locations variables, including those discussed elsewhere herein; and/or (iii) various types of related sensor data, as well as other types of location-related data and information, including those discussed elsewhere herein.

FIG. 4 depicts an exemplary display 400 (e.g., displayed on a display of the user device, 152, 162, a display of the smart device 153, 163, or the display 129, etc.). The exemplary display 400 includes home score 202, and property subscore 402. The property subscore 402 may be derived as described elsewhere herein, such as from (i) property attributes, such as a structure attribute, a systems/appliances attribute, a premises attribute, a fire/electric attribute, a security attribute, and/or a plumbing attribute; (iii) property variables; and/or (iii) various types of property-related sensor data, as well as other types of related data and information, including those discussed elsewhere herein.

### Exemplary Computer-Implemented Methods

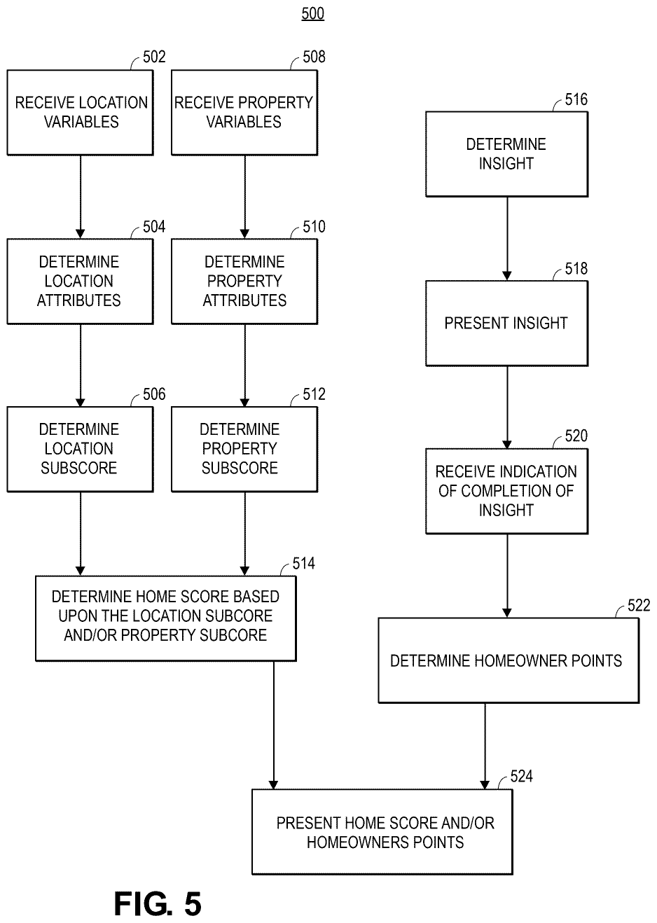

FIG. 5 illustrates a flow diagram representing an exemplary computer-implemented method or implementation 500 for determining and/or displaying: a home score and/or homeowner points. The method 500 may be implemented by a computing environment 100, for example, including the computing device 102, and/or any suitable device including those discussed elsewhere herein, such as one or more local or remote processors, transceivers, memory units, sensors, mobile devices, unmanned aerial vehicles (e.g., drones), etc.

Although the following discussion refers to the exemplary method or implementation 500 as being performed by the one or more processors 120, it should be understood that any or all of the blocks may be alternatively or additionally performed by any other suitable component as well (e.g., the one or more processors of the user device 152, 162, etc.).

The exemplary computer-implemented method or implementation 500 may begin at block 502 when the one or more processors 120 receive location variables. As will be described in further detail elsewhere herein, the location variables may be used to determine location attributes, which may in turn used to determine the location subscore.

The location variables may be received from any suitable source, such as the internal database 118, the external database 180, the memory 122, the smart device(s) 153, 163, the user device 152, 162, a device of the contractor 199, etc.

Broadly speaking, the location variables may be calculated, determined, and/or estimated from sensor and/or other data, such as smart home data, smart vehicle data, home sensor data, mobile device, other sensor data, data stored in databases, historical data, real-time data, etc. Additionally or alternatively, the location variables may be determined by a human expert. For example, a human expert may evaluate the geographic area of the home 150 and determine and/or enter a value for the earthquake variable.

In some implementations, one or more of the location variables may be used to determine the natural hazards attribute. Examples of location variables which may in turn be used to determine the natural hazards attribute include: earthquake variable; wind variable; hail variable; tornado variable; lightning variable; flood variable; vegetation variable; and/or wildfire variable.

In some implementations, one or more of the location variables may be used to determine the emergency response attribute. Examples of location variables which may in turn be used to determine the emergency response attribute include: fire protection variable; and/or hospital distance variable.

In some implementations, one or more of the location variables may be used to determine the health/safety attribute. Examples of location variables which may in turn be used to determine the health/safety attribute include: traffic variable; water hardness variable; air-quality variable; and/or water quality variable.

At block 504 the one or more processors 120 may determine location attributes (e.g., based upon the location variables). The attributes may be determined with or without the use of AI and/or ML. Examples of the location attributes include: a natural hazards attribute, an emergency response attribute, and/or a health/safety attribute.

In some examples, the location attributes may be determined by assigning each variable a score, and then summing, averaging, or taking a weighted average of the scores.

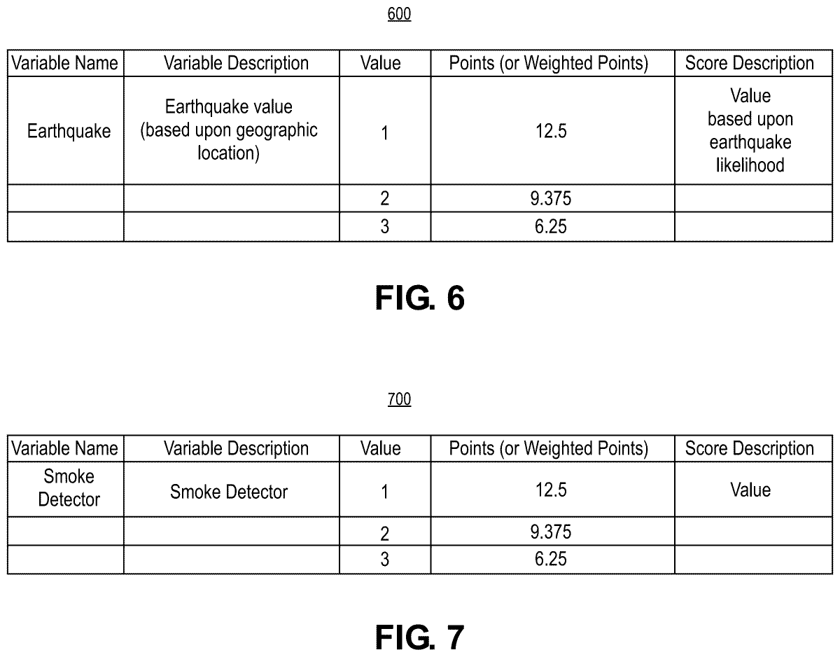

Additionally or alternatively to assigning a score, the variables may be assigned values. By way of exemplary illustration, FIG. 6 shows an exemplary table 600 indicating information of an exemplary earthquake variable. The variable may have a name, which, in the illustrated example, is an earthquake variable. Based upon the risk associated with the variable, a value and/or weighted point value may be given. For example, the variable may be assigned a value, such as a one through three. The value may further be assigned points and/or weighted points. For instance, in the illustrated example, a value of 1 may be assigned 12.5 points; a value of 2 may be assigned 9.375 points; and/or a value of 3 may be assigned 6.25 points.

In some embodiments, when values are missing (e.g., NaN, etc.), they may be filled in with a neutral value. For instance, with respect to the example of FIG. 6, if any of the values are missing, they may be filled in with a value of 1. For example, if the earthquake value is missing, it may be filled in with a value of 1, and thus receive points or weighted points of 6.25.

In some implementations, the values and/or categorical values may be assigned by a vendor evaluating the home 150. The assigned values and/or categorical values may then be stored in a database, and/or sent directly to any other component in FIG. 1.

Additionally or alternatively, individual devices (e.g., as indicated in the profile, etc.) may affect the location subscore and/or home score by a specific amount (e.g., adding a water filter improves the any or all of the water quality variable, the health/safety attribute, and/or the home score; etc.).

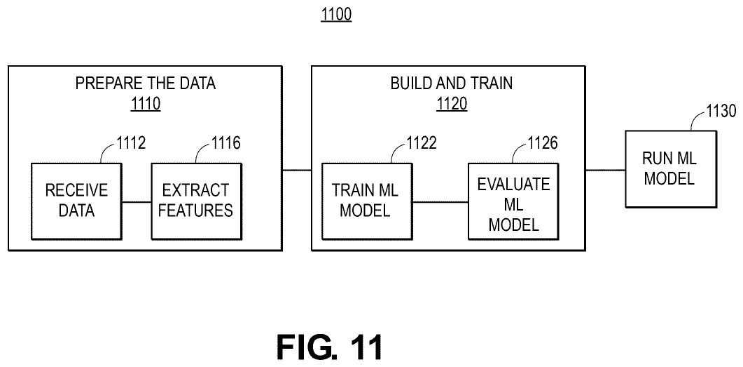

Additionally or alternatively, the one or more processors 120 may determine any of the attribute(s) via machine learning (e.g., trained as described with respect to FIG. 11). For example, location variables may be input into an AI and/or ML algorithm and/or model to determine the attribute(s).

At block 506, the one or more processors 120, may determine the location subscore (e.g., based upon the location attributes, etc.). In some examples, the location subscore is determined by summing, averaging, or taking a weighted average of the location attributes. Advantageously, taking a weighted average of the location attributes may allow an insurance company to specifically tailor the location subscore and/or home score to specific geographic locations. For example, in an area known to have higher rates of natural disasters, the insurance company may determine the location subscore by taking a weighted average of the natural hazards attribute, emergency response attribute, and health/safety attribute, and assigning a higher weight to the natural hazards attribute than to the emergency response attribute, and/or the health/safety attribute.

Additionally or alternatively, the one or more processors 120 may determine the location subscore from sensor and/or other data, such as smart home data, smart vehicle data, home sensor data, mobile device, other sensor data, historical data, data stored in databases, real-time data, etc. Additionally or alternatively, the location subscore may be determined by a human expert. For example, a human expert (e.g., contractor 199, etc.) may inspect the home 150 and manually determine and/or enter a value for home 150 (e.g., via a contractor device, etc.).

Additionally or alternatively, AI and/or ML may be used to determine the location subscore. For example, the location variables may be input into an AI and/or ML algorithm and/or model (e.g., trained as described with respect to FIG. 11) to determine the location subscore.

At block 508, the one or more processors 120 may receive the property variables. As will be described in further detail elsewhere herein, the property variables may be used to determine property attributes, which may in turn used to determine the property subscore.

The property variables may be received from any suitable source, such as the internal database 118, the external database 180, the memory 122, the smart device(s) 153, 163, the user device 152, 162, a device of the contractor 199, etc.

Broadly speaking, the property variables may be calculated, determined, and/or estimated from sensor and/or other data, such as smart home data, smart vehicle data, home sensor data, mobile device, other sensor data, historical data, real-time data, data stored in databases, etc. Additionally or alternatively, the property variables may be determined by a human expert. For example, a human expert (e.g., contractor 199, etc.) may inspect a roof of the home 150 and manually determine and/or enter a value for the roof (e.g., via a contractor device, etc.).

In some implementations, one or more of the property variables may be used to determine the structure attribute. Examples of property variables which may in turn be used to determine the structure attribute include: roof condition variable; hail variable wildfire variable age of home/year built variable; and/or structure type variable (wood, brick, stucco, concrete, etc.).

In some implementations, one or more of the property variables may be used to determine the premises attribute. Examples of property variables which may in turn be used to determine the premises attribute include: tree overhang (e.g., presence of branch over home, size of branch over home; likelihood that branch over home will fall onto home, etc.); wildfire variable; pool feature variable; trees variable (number, size, type, location, etc.); and/or fence variable (e.g., around house, around pool, etc.).

In some implementations, one or more of the property variables may be used to determine the systems/appliances attribute. Examples of property variables which may in turn be used to determine the systems/appliances attribute include: heating, venting, and air conditioning (HVAC) variable, such as based upon: HVAC system type (e.g., heat pump, mini-split, swamp, furnace, AC), system age, system count, system location (e.g., underground, roof, etc.), ducts (e.g., presence, floor, ceiling, material), smart thermostat, fireplace (e.g., presence, type, etc.), maintenance check; and/or appliances variable (e.g., type, age, count).

In some implementations, one or more of the property variables may be used to determine the fire/electric attribute. Examples of property variables which may in turn be used to determine the fire/electric attribute include: fire claims variable (house); an electrical monitoring device variable; and/or smoke detector variable.

In some implementations, one or more of the property variables may be used to determine the security attribute. Examples of property variables which may in turn be used to determine the security attribute include: security system variable (alarm, camera, self-managed versus third-party); motion detected lighting variable; and/or deadbolts on all doors variable.

In some implementations, one or more of the property variables may be used to determine the water/plumbing attribute. Examples of property variables which may in turn be used to determine the water/plumbing attribute include: water claims variable (house); pipe and material variable (e.g., PVC, PEX, copper, cast-iron, etc.); and/or water shutoff valves variable.

At block 510 the one or more processors 120 may determine property attributes (e.g., based upon the property variables). The attributes may be determined with or without the use of AI and/or ML. Examples of the property attributes include: a structure attribute, a systems/appliances attribute, a premises attribute, a fire/electric attribute, a security attribute, and/or a plumbing attribute. In some examples, the property attributes may be determined by assigning each variable a score, and then summing, averaging, taking a weighted average of the scores.

Additionally or alternatively to assigning a score, the variables may be assigned values. By way of exemplary illustration, FIG. 7 shows an exemplary table 700 indicating information of an exemplary smoke detector variable. The variable may have a name, which, in the illustrated example, is a smoke detector variable. Based upon the risk associated with the variable, a value and/or weighted point value may be given. For example, the variable may be assigned a value, such as a one through three. The value may further be assigned points and/or weighted points. For instance, in the illustrated example, a value of 1 may be assigned 12.5 points; a value of 2 may be assigned 9.375 points; and/or a value of 3 may be assigned 6.25 points.

In some embodiments, when values are missing (e.g., NaN, etc.), they may be filled in with a neutral value. For instance, with respect to the example of FIG. 7, if any of the values are missing, they may be filled in with a value of 1. For example, if the smoke detector value is missing, it may be filled in with a value of 1, and thus receive points or weighted points of 6.25.

In some implementations, the values may be assigned by a vendor evaluating the home 150. The assigned values may then be stored in a database, and/or sent directly to any other component in FIG. 1.

Additionally or alternatively, individual devices (e.g., as indicated in the profile, etc.) may affect the property subscore and/or home score by a specific amount (e.g., adding a smoke detector improves the any or all of the smoke detector variable, the fire/electric attribute, property subscore, and/or the home score, etc.). In addition, in some embodiments, each device affects the home score incrementally (e.g., each smart smoke detector added adds one point to the smoke detector variable, etc.). However, in some such embodiments, there is a maximum number of devices that may continue to improve the variable and/or home score (e.g., the first 5 smoke detectors each improve the smoke detector variable by 1 point, but the sixth does not improve the smoke detector variable). In some certain embodiments, the improvements are phased out (e.g., the first four smoke detectors each improve the smoke detector variable by 1 point, the next 3 smoke detectors improve the smoke detector variable by half a point, and the subsequent smoke detectors do not improve the smoke detector variable). Furthermore, different models of a device may have different impacts on the home score(s) (e.g., a basic model smart smoke detector improves a smoke detector variable by 2 points, and a more advanced model improves the smoke detector variable by 4 points). As such, the variable and/or home score may be affected by both the model and the quantity of the device.

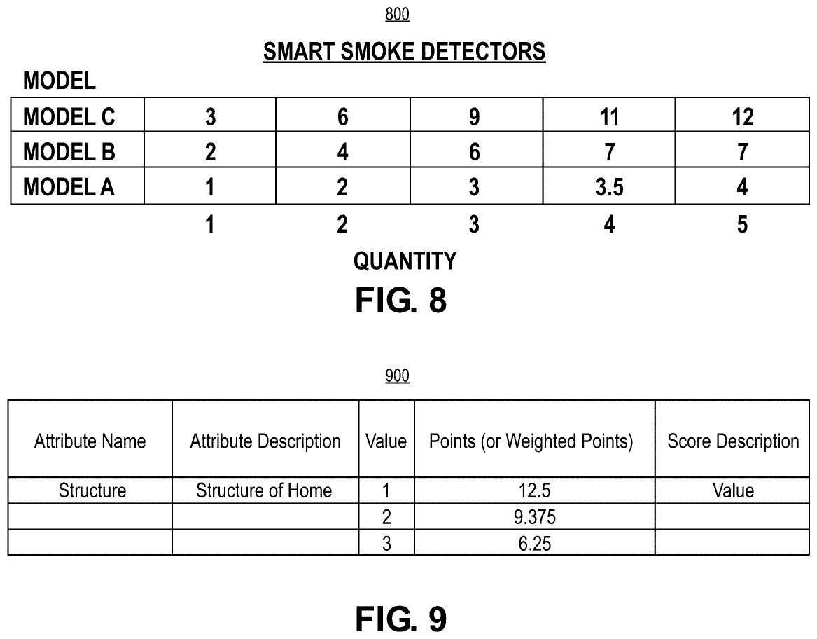

To this end, the variable may also comprise a matrix of devices. For example, for any of the variables (including the location variables and/or property variables), there may be device matrix(es) for particular devices. For instance, FIG. 8 depicts exemplary matrix 800 of smart smoke detectors indicating points that the smart smoke detectors increase the smoke detector variable, fire/electric attribute, property subscore, and/or home score by. The exemplary matrix 800 depicts both model and quantity of the device, with the numbers in the matrix indicating how the devices affect the smoke detector variable, fire/electric attribute, and/or home score. For example, as illustrated, a smoke detector variable for a home with one model A smoke detector would get 1 point for the model A smoke detector. In another illustrated example, a smoke detector variable for a home with three model C smoke detectors would get 9 points for the smoke detectors.

Additionally or alternatively, the location attributes and/or property attributes themselves may be in the form of a value, weighted value, points, and/or weighted points similarly as described with respect to the variables. For example, in some embodiments, there may be no variables and the attributes are directly assigned a value, weighted value, points, and/or weighted points.

FIG. 9 shows an exemplary structural attribute 900. In some examples, the structural attribute is assigned (e.g., by a human expert in building and/or construction) a value assessing the structural quality of the home 150.

Additionally or alternatively, the one or more processors 120 may determine any of the attribute(s) via machine learning (e.g., trained as described with respect to FIG. 11). For example, property variables may be input into an AI and/or ML algorithm and/or model to determine the attribute(s).

At block 512, the one or more processors 120, may determine the property subscore (e.g., based upon the property attributes, etc.). In some examples, the property subscore is determined by summing, averaging, or taking a weighted average of the property attributes. Advantageously, taking a weighted average of the property attributes may allow an insurance company to specifically tailor the property subscore and/or home score to specific geographic locations. For example, in an area known to have higher rates of fire, the insurance company may determine the property subscore by taking a weighted average of the structure attribute, systems/appliances attribute, premises attribute, fire/electric attribute, security attribute, and/or plumbing attribute, and assigning a higher weight to the fire/electric attribute than to the other attribute(s).

Additionally or alternatively, the one or more processors 120 may determine the property subscore from sensor and/or other data, such as smart home data, smart vehicle data, home sensor data, mobile device, other sensor data, historical data, other property-related data and information, etc. Additionally or alternatively, the property subscore may be determined by a human expert. For example, a human expert (e.g., contractor 199, etc.) may inspect the home 150 and manually determine and/or enter a value for home 150 (e.g., via a contractor device, etc.).

Additionally or alternatively, AI and/or ML may be used to determine the property subscore. For example, the property attributes may be input into an AI and/or ML algorithm and/or model (e.g., trained as described with respect to FIG. 11) to determine the property subscore.

At block 514, the one or more processors 120 may determine the home score (e.g., based upon the location subscore and/or property subscore). In some examples where the location attribute and property attribute are assigned scores, the home score may be determined by summing, averaging, or taking a weighted average of the scores.

Additionally or alternatively, AI and/or ML may be used to determine the home score. For example, the location subscore and property subscore may be input into an AI and/or ML algorithm and/or model (e.g., trained as described with respect to FIG. 11) to determine the home score.

At block 516, the one or more processors 120 may determine an insight (e.g., a recommended project to improve the property 150, 160, a recommendation to learn a new homeowner skill, etc.). Examples of the insights include:
locating a water main valve and learning how to shut it off;
checking a smoke detector battery;
locating gas main and learning how to shut it off;
changing a heating, venting, and cooling (HVAC) filter;
performing water heater maintenance (e.g., draining or flushing a hot water heater);
checking toilets for running water and/or leaks around seal at base;
locating a circuit breaker box;
inspecting and/or cleaning dryer vents;
servicing and/or inspecting air conditioner;
checking for drainage issues (e.g., standing water around the house, etc.);
checking any or all door and window seals to ensure tight seals with no gaps;
inspecting and/or unclogging sink, tub and/or shower drains;
cleaning HVAC ducts;
testing carbon monoxide detectors and/or replacing batteries;
installing water sensors in areas at risk for leaks;
placing extensions at gutter downspout bases to direct water away from foundation;
checking washing machine hoses for fraying, cracks or leaks;
installing a water monitor/leak detector to detect small leaks (e.g., before they become a larger problem);
inspecting plumbing fixtures;
vacuuming HVAC vents and registers;
learning about home systems and appliances and their typical lifespan;
inspecting roof;
cleaning washing machine with a washing machine cleaning solution;
checking for recalls on your appliances;
cleaning dishwasher screen filter;
checking gauge and expiration on fire extinguishers;
having energy audit to discover drafts, air leaks and energy inefficiencies;
cleaning and/or lubricating window tracks and/or cranking out window operators;
checking and recaulking tile and/or countertops (e.g., on sinks, showers, bathtubs, etc.);
increasing air conditioning thermostat temperature when away from property;
unplugging appliances and shutoff water supply valves to toilets and/or washing machine (e.g., if leaving property for an extended period);
checking the hose between the wall and the refrigerator to determine if it is pinched or stressed, and/or searching hose for signs of leaking, wear and/or tear;
adding an air quality monitor;
checking fencing for gaps or breaks;
utilizing a dehumidifier to keep damp areas free of mold and mildew in warmer months;
testing for radon;
having sprinkler/irrigation system serviced;
installing and/or cleaning window screens and/or checking for holes;
filling cracks and/or sealing asphalt or concrete in walkways and/or driveways;
installing low-flow shower heads and toilets to reduce water waste;
installing exterior lighting;
adding an electrical monitoring device;
setting sprinklers for very early morning (e.g., before sunrise);
having fireplace inspected;
examining and/or testing a sump pump;
installing a whole home automatic water shutoff valve;
testing Ground Fault Circuit Interrupter (GFCI) outlets;
checking yard for soil erosion;
checking landscaping for hazardous trees and tree limbs;
removing insulation from outdoor faucets;
testing well water (e.g., every 6 months, etc.);
planting flowers and shrubs in front to boost curb appeal;
testing sprinkler system and inspecting for breaks;
installing a sump pump; and/or
switching to renewable energy source(s).

The insight(s) may be determined by any suitable technique. For example, the insight(s) may be determined by selecting from a list of insights. For example, the list may be prioritized, and the insight(s) with the highest priority may be selected. The user 151 may select, via the app, how many insight(s) will be determined. In some examples, the insights are determined based at least in part upon a geographic location of the home 150. For example, advantageously, in a geographic area known to be prone to flooding and/or intense rain, insights related to water protection (e.g., installing a sump pump, etc.) may be given a higher priority.

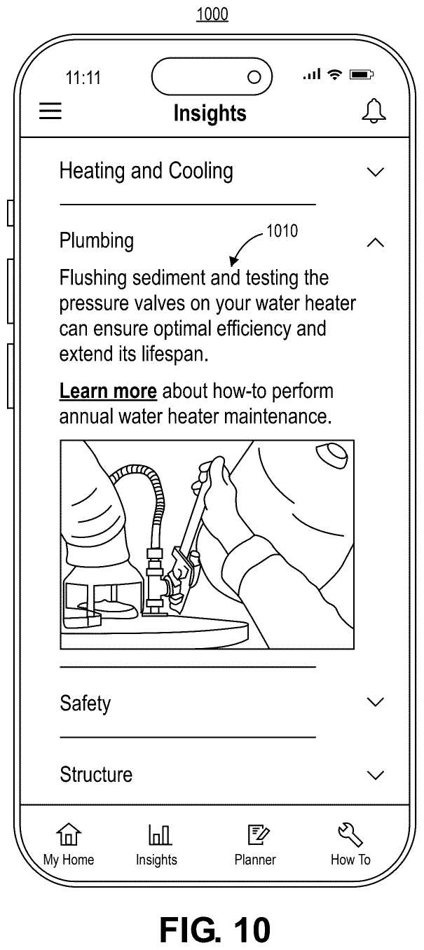

At block 518, the one or more processors 120 may present (e.g., cause to be presented, etc.) the determined insight(s). For example, the insight may be displayed on a display of the user device 152, 162. To this end, FIG. 10 depicts an exemplary screen 1000 displaying an exemplary insight. In this example, an explanation 1010 of the benefits of the insight is also displayed. Additionally or alternatively, the presentation of the insight may be auditory (e.g., the insight is stated or explained through a speaker of the user device 152, 162, etc.).

At block 520, the one or more processors 120 may receive an indication of completion of an insight. In some examples, this may include verifying that the one or more insights are finished by: analyzing a receipt (e.g., uploaded by the user 151 via the user device 152), analyzing a photo (e.g., uploaded by the user 151 via the user device 152), and/or receiving verification from a contractor (e.g., uploaded by the contractor 199 via a device of the contractor 199). Advantageously, including a verification requirement improves computer security of the system.

Further advantageously, the user device 152 may compress the photo before sending it to the computing device 102. The computing device 102 may then uncompress the photo and analyze the uncompressed photo to determine that the one or more insights have been completed. The advantageously minimizes network load and enhances the system's responsiveness.

At block 522, the one or more processors 120 may determine homeowner points. In some aspects, the homeowner points enhance the user's 151 experience (e.g., by gamifying the process of improving her home). Moreover, the insurance company may offer the user 151 a discount on insurance when the user 151 reaches a predetermined number of homeowner points.

In some examples, the homeowner points start at a predetermined value (e.g., 0 homeowner points, 10 homeowner points, 100 homeowner points, 1,000 homeowner points, 10,000 homeowner points, etc.). In some embodiments, the homeowner points are increased upon completion of an insight. In some embodiments, the homeowner points are decreased if the user 151 has not completed an insight (e.g., maintenance, such as changing an air filter, etc.) within a particular time period (e.g., by a predetermined time). The homeowner points may be determined with or without the use of AI and/or ML. In some embodiments which use AI and/or ML, an AI and/or ML algorithm or model may be trained as described with respect to FIG. 11.

At block 524, the one or more processors 120 may present (e.g., cause to be presented, etc.) the home score and/or homeowner points. For example, the homeowner points may be displayed on a display of the user device 152, 162. For example, FIG. 2 depicts an exemplary screen 200 including exemplary homeowner points 204. In the illustrated example, the home score is displayed in an upper portion 210 of the display, and the homeowner points 204 are displayed in a lower portion 212 of the display. Advantageously, this emphasizes the home score over the homeowner points. Additionally or alternatively, the presentation of the homeowner points may be auditory (e.g., the homeowner points are stated or explained through a speaker of the user device 152, 162, etc.).

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Exemplary AI and/or ML Techniques

In some embodiments, AI and/or ML algorithm(s) and/or model(s) may be used to partially or wholly determine the: (i) attribute(s) (e.g., the location attributes and/or the property attributes, etc.), (ii) subscore(s) (e.g., the location subscore and/or property subscore, etc.) (iii) home score, and/or (iv) homeowner points. Although the following discussion refers to an ML algorithm, it should be appreciated that it applies equally to ML and/or AI algorithms and/or models.

FIG. 11 is a block diagram of an exemplary machine learning modeling method 1100 for training and evaluating a ML algorithm (e.g., an attribute determining ML algorithm, a subscore determining ML algorithm, a home score determining ML algorithm, a homeowner points determining ML algorithm, etc.), in accordance with various embodiments. In some embodiments, the model “learns” an algorithm capable of performing the desired function, such as determining a subscore. It should be understood that the principles of FIG. 11 may apply to any machine learning algorithm discussed herein.

Although the following discussion refers to the blocks of FIG. 11 as being performed by the one or more processors 120, it should be appreciated that the blocks of FIG. 11 may be performed by any suitable component or combinations of components (e.g., one or more processors of any of the user devices 152, 162, etc.).

At a high level, the machine learning modeling method 1100 includes a block 1110 to prepare the data, a block 1120 to build and train the model, and a block 1130 to run the model.

Block 1110 may include sub-blocks 1112 and 1116. At block 1112, the one or more processors 120 may receive the historical information to train the machine learning algorithm. In some examples, the historical information comprises: (i) inputs to the machine learning model (e.g., also referred to as independent variables, or explanatory variables), and/or (ii) outputs of the machine learning model (e.g., also referred to as dependent variables, or response variables).

In some such examples, the dependent variables are the outputs that the ML algorithm is trained to determine; and the independent variables are used to determine the dependent variables. Put another way, the independent variables may have an impact on the dependent variables; and the ML algorithms may be trained to find this impact. Therefore, when using a trained ML algorithm to determine an output, information corresponding to the historical information that the ML was trained on may be routed into the ML algorithm to determine the initial value or an update to an attribute, subscore, or home score. For example, variables may be input into the ML algorithm to determine attribute(s).

For the historical information used to train a location attribute determining machine learning algorithm, examples of the historical information include historical: (i) independent variables comprising location variables (e.g., historical earthquake variables, historical wind variables, historical hail variables, etc.); and/or (ii) dependent variables comprising location attributes.

For the historical information used to train a property attribute determining machine learning algorithm, examples of the historical information include historical: (i) independent variables comprising property variables (e.g., historical roof condition variables, historical hail vulnerability variables, historical wildfire vulnerability variables, etc.); and/or (ii) dependent variables comprising property attributes.

For the historical information used to train a location subscore determining machine learning algorithm, examples of the historical information include historical: (i) independent variables comprising location attributes (e.g., historical natural hazards attributes, historical emergency response attributes, historical health/safety attributes, etc.); and/or (ii) dependent variables comprising location subscores.

For the historical information used to train a property subscore determining machine learning algorithm, examples of the historical information include historical: (i) independent variables comprising property attributes (e.g., historical structure attributes, historical systems/appliances attributes, historical premises attributes, historical fire/electric attributes, historical security attributes, historical plumbing attributes, etc.); and/or (ii) dependent variables comprising property subscores.

For the historical information used to train a home score determining machine learning algorithm, examples of the historical information include historical: (i) independent variables comprising: (a) location subscores, and/or (b) property subscores, and/or (ii) dependent variables comprising home scores.

For the historical information used to train a homeowner points determining machine learning algorithm, examples of the historical information include historical: (i) independent variables comprising completed or uncompleted insights (e.g., historical locating a water main valve and learning how to shut it off, historical checking a smoke detector battery, historical locating gas main and learning how to shut it off, etc.), and/or (ii) dependent variables comprising homeowners points.

Examples of any of the machine learning algorithms discussed above include: generative AI, deep learning algorithm(s), neural networks, convolutional neural networks, linear regression algorithm(s), logistic regression algorithm(s), decision trees, random forests, support vector machines, k-nearest neighbors, naïve bayes, an ensemble model (e.g., boosting algorithm(s), etc.), hidden Markov models, k-means clustering algorithm(s), and reinforcement learning algorithm(s) (e.g., Q-learning algorithm(s), deep Q-network algorithm(s), etc.), which may be employed individually or in combination with additional machine learning algorithms, including those mentioned herein.

The historical information may be received from any suitable source. Examples of sources that any of the historical information may be received from include: memory 122, internal database 118, external database 180, smart devices 153, 163, user devices 152, 162, etc. It should be appreciated that the historical information may be received from combinations of these sources as well.

Block 1120 may include sub-blocks 1122 and 1126. At block 1122, the machine learning (ML) model is trained (e.g., based upon the data received from block 1110). In some embodiments where associated information is included in the historical information, the ML model “learns” an algorithm capable of calculating or predicting the target feature values (e.g., determining an attribute, a subscore, a home score, homeowner points, etc.) given the predictor feature values. The training process of bock 1122 may include a supervised, unsupervised, semi-supervised, and/or reinforcement learning process(s). The model may be a deep learning model, a neural network, a convolutional neural network, etc.

At block 1126, the one or more processors 120 may evaluate the machine learning model, and determine whether or not the machine learning model is ready for deployment.

Further regarding block 1126, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information, such as the historical information discussed above), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

Moreover, it should be appreciated the ML algorithm may be any kind of ML algorithm (e.g., neural network, convolutional neural network, deep learning algorithm, etc.).

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Exemplary Biometric Authentication—Improved Security

Advantageously, to improve system security, biometric authentication and/or two factor authentication may be used.

For example, prior to determining the location subscore and/or property subscore, the one or more processors 120 may receive, from the user device 152: (i) a username, (ii) a password corresponding to the user name, and/or (iii) biometric data corresponding to the username. In some examples, the biometric data includes facial data and/or fingerprint data. In response to determining that the received username, password, and/or biometric data matches data from a user account, the one or more processors 120 may send a generated code (e.g., via text message, email, audio recording, etc.) including numbers, letters, and/or symbols to the user device 152. Subsequent to sending the generated code, the one or more processors 120 may receive, from the user device 152, a received code (e.g., entered into the user device 152 by the user 151). Next, the one or more processors 120 may authenticate the user device 152 by verifying that the generated code matches the received code. Then, in response to the authentication, the one or more processors 120 may determine the location subscore and/or the determining the property subscore.

### Additional Exemplary Embodiments

In one aspect, a computer-implemented method for determining and/or displaying: a home score and/or homeowner points may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the computer-implemented method may include: (1) determining, via one or more processors, a location subscore (such from location-related sensor and other data, as described elsewhere herein); (2) determining, via the one or more processors, a property subscore (such as from property-related sensor and other data, as described elsewhere herein); (3) determining, via the one or more processors, a home score based upon the location subscore and/or property subscore; (4) determining, via the one or more processors, homeowner points based upon completion of one or more insights; and/or (5) displaying, via the one or more processors, the home score and/or the homeowner points. The method may include additional, fewer, or alternate actions, including those discussed elsewhere herein.

In some embodiments, the determining the location subscore may include determining, via the one or more processors, the location subscore based upon a natural hazards attribute, an emergency response attribute, and/or a health/safety attribute.

In some embodiments, the determining the property subscore may include determining the property subscore based upon a structure attribute, a systems/appliances attribute, a premises attribute, a fire/electric attribute, a security attribute, and/or a plumbing attribute.

In some embodiments, the determining the home score may include determining the home score by averaging the location subscore and/or property subscore.

In some embodiments, the one or more insights may include at least one insight for: locating a main water valve and learning how to shut off the main water valve; checking a smoke detector battery; locating gas main and learning how to shut off the gas main; changing a heating, venting, and cooling (HVAC) filter; performing water heater maintenance; cleaning faucets and/or showerheads to remove mineral deposits; checking toilets for running water and/or leaks around seal at base; locating a circuit breaker box; inspecting and/or cleaning dryer vents; and/or searching foundation and/or walls for water leaks or damage.

In some embodiments, the completion may include verifying that the one or more insights are finished by: analyzing a receipt, analyzing a photo, and/or receiving verification from a contractor.

In some embodiments, the computer-implemented method may further include: receiving, by the one or more processors, a compressed photo; uncompressing, via the one or more processors, the compressed photo; and/or verifying, by the one or more processors, that the one or more insights are finished by analyzing the uncompressed photo.

In some embodiments, the displaying may include displaying the home score in an upper portion of a display, and/or displaying the homeowner points in a lower portion of the display.

In some embodiments, the computer-implemented method may further include: prior to determining the location subscore and/or property subscore, receiving, via the one or more processors, from a user device: (i) a username, (ii) a password corresponding to the user name, and/or (iii) biometric data corresponding to the username, wherein the biometric data includes facial data and/or fingerprint data; in response to determining that the received username, password, and/or biometric data matches data from a user account, sending, via the one or more processors, a generated code including numbers, letters, and/or symbols to the user device; subsequent to the sending, receiving, via the one or more processors, from the user device, a received code; and/or authenticating, via the one or more processors, the user device by verifying that the generated code matches the received code; and/or wherein the determining the location subscore and/or the determining the property subscore is/are done in response to the authenticating.

In another aspect, a computer device configured for determining and/or displaying: a home score and/or homeowner points may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) determine a location subscore; (2) determine a property subscore; (3) determine a home score based upon the location subscore and/or property subscore; (4) determine homeowner points based upon completion of one or more insights; and/or (5) display the home score and/or the homeowner points. The computer device may include additional, less, or alternate functionality, including that discussed elsewhere herein.

In some embodiments, the one or more processors are further configured to determine the location subscore by determining the location subscore based upon a natural hazards attribute, an emergency response attribute, and/or a health/safety attribute.

In some embodiments, the one or more processors are further configured to determine the property subscore by determining the property subscore based upon a structure attribute, a systems/appliances attribute, a premises attribute, a fire/electric attribute, a security attribute, and/or a plumbing attribute.

In some embodiments, the one or more processors are further configured to determine the home score by averaging the location subscore and/or property subscore.

In some embodiments, one or more insights includes at least one insight for: locating a main water valve and/or learning how to shut off the main water valve; checking a smoke detector battery; locating gas main and/or learning how to shut off the gas main; changing a heating, venting, and cooling (HVAC) filter; performing water heater maintenance; cleaning faucets and/or showerheads to remove mineral deposits; checking toilets for running water and/or leaks around seal at base; locating a circuit breaker box; inspecting and/or cleaning dryer vents; and/or searching foundation and/or walls for water leaks or damage.

In some embodiments, the one or more processors are further configured to determine the homeowner points based upon completion of one or more insights by verifying that the one or more insights are finished by: analyzing a receipt, analyzing a photo, and/or receiving verification from a contractor.

In some embodiments, the one or more processors are further configured to: receive a compressed photo; uncompress the compressed photo; and/or verify that the one or more insights are finished by analyzing the uncompressed photo.

In some embodiments, the one or more processors are further configured to display the home score in an upper portion of a display, and/or display the homeowner points in a lower portion of the display.

In yet another aspect, a computer system configured for determining and/or displaying: a home score and/or homeowner points may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) determine a location subscore; (2) determine a property subscore; (3) determine a home score based upon the location subscore and/or property subscore; (4) determine homeowner points based upon completion of one or more insights; and/or (5) display the home score and/or the homeowner points. The computer system may include additional, less, or alternate functionality, including that discussed elsewhere herein.

In some embodiments, the one or more non-transitory memories having stored thereon computer-executable instructions that, when executed by the one or more processors, cause the one or more processors to: receive a compressed photo; uncompress the compressed photo; and/or verify that the one or more insights are finished by analyzing the uncompressed photo.

In some embodiments, the one or more non-transitory memories having stored thereon computer-executable instructions that, when executed by the one or more processors, cause the one or more processors to: receive a compressed photo; uncompress the photo; and/or verify that the one or more insights are finished by analyzing the uncompressed photo.

In some embodiments, the computer system further includes a display device, and/or wherein the non-transitory memories having stored thereon computer-executable instructions that, when executed by the one or more processors, cause the one or more processors to: display the home score and/or the homeowner points by displaying the home score and/or the homeowner points on the display device.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for determining and displaying: a home score and homeowner points, the computer-implemented method comprising:
determining, via one or more processors, a location subscore;
determining, via the one or more processors, a property subscore;
determining, via the one or more processors, a home score based upon the location subscore and property subscore;
determining, via the one or more processors, homeowner points based upon completion of one or more insights; and
displaying, via the one or more processors, the home score and the homeowner points.

2. The computer-implemented method of claim 1, wherein the determining the location subscore includes determining, via the one or more processors, the location subscore based upon a natural hazards attribute, an emergency response attribute, and/or a health/safety attribute.

3. The computer-implemented method of claim 1, wherein the determining the property subscore includes determining the property subscore based upon a structure attribute, a systems/appliances attribute, a premises attribute, a fire/electric attribute, a security attribute, and/or a plumbing attribute.

4. The computer-implemented method of claim 1, wherein the determining the home score includes determining the home score by averaging the location subscore and property subscore.

5. The computer-implemented method of claim 1, wherein the one or more insights includes at least one insight for:
locating a main water valve and learning how to shut off the main water valve;
checking a smoke detector battery;
locating gas main and learning how to shut off the gas main;
changing a heating, venting, and cooling (HVAC) filter;
performing water heater maintenance;
cleaning faucets and/or showerheads to remove mineral deposits;
checking toilets for running water and/or leaks around seal at base;
locating a circuit breaker box;
inspecting and/or cleaning dryer vents; and/or
searching foundation and/or walls for water leaks or damage.

6. The computer-implemented method of claim 1, wherein the completion includes verifying that the one or more insights are finished by: analyzing a receipt, analyzing a photo, and/or receiving verification from a contractor.

7. The computer-implemented method of claim 1, further including:
receiving, by the one or more processors, a compressed photo;
uncompressing, via the one or more processors, the compressed photo; and
verifying, by the one or more processors, that the one or more insights are finished by analyzing the uncompressed photo.

8. The computer-implemented method of claim 1, wherein the displaying includes displaying the home score in an upper portion of a display, and displaying the homeowner points in a lower portion of the display.

9. A computer device for determining and displaying: a home score and homeowner points, the computer device comprising one or more processors configured to:
determine a location subscore;
determine a property subscore;
determine a home score based upon the location subscore and property subscore;
determine homeowner points based upon completion of one or more insights; and
display the home score and the homeowner points.

10. The computer device of claim 9, wherein the one or more processors are further configured to determine the location subscore by determining the location subscore based upon a natural hazards attribute, an emergency response attribute, and/or a health/safety attribute.

11. The computer device of claim 9, wherein the one or more processors are further configured to determine the property subscore by determining the property subscore based upon a structure attribute, a systems/appliances attribute, a premises attribute, a fire/electric attribute, a security attribute, and/or a plumbing attribute.

12. The computer device of claim 9, wherein the one or more processors are further configured to determine the home score by averaging the location subscore and property subscore.

13. The computer device of claim 9, wherein the one or more insights includes at least one insight for:
locating a main water valve and learning how to shut off the main water valve;
checking a smoke detector battery;
locating gas main and learning how to shut off the gas main;
changing a heating, venting, and cooling (HVAC) filter;
performing water heater maintenance;
cleaning faucets and/or showerheads to remove mineral deposits;
checking toilets for running water and/or leaks around seal at base;
locating a circuit breaker box;
inspecting and/or cleaning dryer vents; and/or
searching foundation and/or walls for water leaks or damage.

14. The computer device of claim 9, wherein the one or more processors are further configured to determine the homeowner points based upon completion of one or more insights by verifying that the one or more insights are finished by: analyzing a receipt, analyzing a photo, and/or receiving verification from a contractor.

15. The computer device of claim 9, wherein the one or more processors are further configured to:
receive a compressed photo;
uncompress the compressed photo; and
verify that the one or more insights are finished by analyzing the uncompressed photo.

16. The computer device of claim 9, wherein the one or more processors are further configured to display the home score in an upper portion of a display, and display the homeowner points in a lower portion of the display.

17. A computer system for determining and displaying: a home score and homeowner points, the computer system comprising:
one or more processors; and
one or more non-transitory memories, the one or more non-transitory memories having stored thereon computer-executable instructions that, when executed by the one or more processors, cause the one or more processors to:
determine a location subscore;
determine a property subscore;
determine a home score based upon the location subscore and property subscore;
determine homeowner points based upon completion of one or more insights; and
display the home score and the homeowner points.

18. The computer system of claim 17, the one or more non-transitory memories having stored thereon computer-executable instructions that, when executed by the one or more processors, cause the one or more processors to:
determine the home score by averaging the location subscore and property subscore.

19. The computer system of claim 17, the one or more non-transitory memories having stored thereon computer-executable instructions that, when executed by the one or more processors, cause the one or more processors to:
receive a compressed photo;
uncompress the photo; and
verify that the one or more insights are finished by analyzing the uncompressed photo.

20. The computer system of claim 17, further comprising a display device, and wherein the non-transitory memories having stored thereon computer-executable instructions that, when executed by the one or more processors, cause the one or more processors to:
display the home score and the homeowner points by displaying the home score and the homeowner points on the display device.
